(19) United States
(12) Patent Application Publication
(10) Pub. No.: US 2003/0171242 A1
(43) Pub. Date: Sep. 11, 2003

(54) Cold cleaning compositions of the microemulsions type

(76) Inventors: Pascal Michaud, Saint-Gratien (FR); Jean-Jacques Martin, Bois-Colombes (FR); Pascal Brochette, La Gacilly (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/351,432

(22) Filed: Jan. 27, 2003

Related U.S. Application Data
(63) Continuation of application No. 09/598,265, filed on Jun. 21, 2000.

(30) Foreign Application Priority Data
Jun. 21, 1999 (FR) 9907848

(51) Int. Cl. C11D 17/00

(52) U.S. Cl. 510/417; 510/505; 510/506

(57) ABSTRACT

Cleaning composition which is provided in the form of a microemulsion which is stable at room temperature, the said composition comprising (A) water; (B) at least one organic solvent which is liquid at room temperature; and (C) at least one surface-active agent, characterized in that (A) represents from 30 to 70 parts by weight; (B) represents from 20 to 60 parts by weight; and (C) represents from 5 to 30 parts by weight, (A)+(B)+(C) representing 100 parts by weight; and the organic solvent or solvents (B) being chosen from aliphatic alcohols; aliphatic esters; aliphatic diesters; aliphatic hydrocarbons; halogenated aliphatic hydrocarbons; aromatic hydrocarbons; aliphatic ketones; aliphatic ethers; alkylene glycol, dialkylene glycol and trialkylene glycol monoethers; (di)alkylene glycol diethers; and (di)alkylene glycol ether acetates; and the surface-active agent or agents (C) being chosen from those of the formula (I):

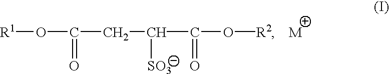

R₁ and R₂=each independently linear or branched C₅-C₂₀ alkyl; M=cation chosen from Na⁺, and K⁺ and NR₄⁺, where R=each independently H or C₁-C₄ alkyl.

The present invention relates to a cleaning composition of the microemulsion type which can be used in particular for the cold cleaning (that is to say, at room temperature) of surfaces of metal components, of ceramics, of glasses, of plastics, of printed circuits, and the like.

These surfaces were conventionally cleaned with 1,1,1-trichloroethane, a highly versatile solvent but one which has been condemned by the Montreal Protocol because of its impact on the ozone layer.

It has been found that it is then possible to use so-called microemulsion compositions, which make it possible to clean both inorganic and organic contaminants as they combine an organic solvent part and an aqueous part. The aqueous part is generally sizeable and comprises a surface-active agent. Microemulsions appear to be transparent solutions which are thermodynamically stable and easy to prepare. This is explained by virtue of the high content of surfactant, which allows a large number of them to be formed. Depending on the hydrocarbon used (in the organic solvent phase), a stability range or a stability interval for the microemulsion with the temperature can be relatively narrow (10 to 15° C.), which can be troublesome on storage or according to the operating conditions, as the microemulsion can separate into the two phases: aqueous part/organic solvent part.

Thus, the microemulsions currently available on the market do not display the expected effectiveness and exhibit instability with regard to the temperature when values of about 35° C. are reached.

The Applicant Company has sought to overcome this disadvantage and thus to enhance the temperature stability range of microemulsions with a low viscosity for cold use. This has allowed it to discover that specific surface-active agents can lower the viscosity of solvents with high boiling points for the purpose of their cold use, facilitating their use without having to heat the combined mixture (saving of energy) and making it possible to dispense with the regulations relating to volatile organic compounds (referred to as VOCs), if the level of solvent is less than 30% by weight of the composition.

A subject-matter of the present invention is therefore a cleaning composition which is provided in the form of a microemulsion which is stable at room temperature, the said composition comprising:

(A) water;

(B) at least one organic solvent which is liquid at room temperature; and

(C) at least one surface-active agent,

characterized in that:

(A) represents from 30 to 70 parts by weight, in particular 35 to 60 parts by weight;

(B) represents from 20 to 60 parts by weight, in particular 25 to 55 parts by weight; and

(C) represents from 5 to 30 parts by weight, in particular 10 to 25 parts by weight,

(A)+(B)+(C) representing 100 parts by weight; and

the organic solvent or solvents (B) being chosen from:

(1) aliphatic alcohols;

(2) aliphatic esters;

(3) aliphatic diesters;

(4) aliphatic hydrocarbons;

(5) halogenated aliphatic hydrocarbons;

(6) aromatic hydrocarbons;

(7) aliphatic ketones;

(8) aliphatic ethers;

(9) alkylene glycol, dialkylene glycol and trialkylene glycol monoethers;

(10) (di)alkylene glycol diethers; and

(11) (di)alkylene glycol ether acetates; and

the surface-active agent or agents (C) being chosen from those of the formula (I):

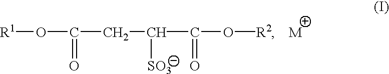

in which:

R¹ and R² each independently represent a linear or branched C₅-C₂₀ alkyl radical;

M is a cation chosen from Na⁺, K⁺ and NR₄⁺, the R groups each independently representing hydrogen or a C₁-C₄ alkyl radical.

(1) The aliphatic alcohols can be primary, secondary or tertiary alcohols. They have in particular from 4 to 24 carbon atoms. Mention may be made, as examples of these alcohols, of octanol, 2-ethyl-hexanol, nonanol, dodecanol, undecanol and decanol.

(2) The aliphatic esters have in particular from 4 to 24 carbon atoms. Mention may be made, as examples of these esters, of methyl laurate, methyl oleate, hexyl acetates, pentyl acetates, octyl acetates, nonyl acetates and decyl acetates, and methyl, ethyl, propyl, butyl and hexyl lactates.

(3) The aliphatic diesters comprise in particular 6 to 24 carbon atoms. Mention may be made, as examples, of dimethyl adipate, dimethyl succinate, dimethyl glutarate, diisobutyl adipate and diisobutyl maleate.

(4) The aliphatic hydrocarbons can be linear, branched or cyclic hydrocarbons or their combinations. They comprise in particular from 3 to 24 carbon atoms, preferably 6 to 24 carbon atoms. Mention may be made, as examples of these aliphatic hydrocarbons, of alkanes, such as liquid propane, butane, hexane, octane, decane, dodecane, hexadecane, mineral oils, paraffin oils, decahydronaphthalene, bicyclohexane or cyclohexane, and olefins, such as 1-decene, 1-dodecene, octadecene and hexadecene.

Examples of commercially available aliphatic hydrocarbons are:

Norpar™ 12, 13 and 15 (normal paraffin solvents available from the Company “Exxon Corporation”);

Isopar™ G, H, K, L, M or V (isoparaffin solvents available from the Company “Exxon Corporation”);

Shellsol™ solvents (available from the Company “Shell Chemical Company”);

Petrosolv™ D-15/20, D-19/22, D-20/26, D-24/27 or D-28/31 from Cepsa (paraffin and isoparaffin solvents available from the Company “Cepsa”); and

the hydrocarbonaceous solvents Exxsol™, sold by the Company “Exxon Corporation”.

(5) The halogenated aliphatic hydrocarbons, in particular chlorinated aliphatic hydrocarbons, comprise 1 to 12, in particular 2 to 6, carbon atoms. Mention may be made, as examples of these chlorinated aliphatic hydrocarbons, of methylene chloride, carbon tetrachloride, chloroform, 1,1,1-trichloroethane, perchloroethylene and trichloroethylene.

(6) The aromatic hydrocarbons comprise in particular 6 to 24 carbon atoms. Mention may be made, as examples of these aromatic hydrocarbons, of toluene, naphthalene, biphenyl, ethylbenzene, xylene and alkylbenzenes, such as dodecylbenzene, octylbenzene and nonylbenzene.

(7) The aliphatic ketones have in particular 4 to 24 carbon atoms. Mention may be made, as examples of these ketones, of methyl ethyl ketone, diethyl ketone, diisobutyl ketone, methyl isobutyl ketone and methyl hexyl ketone.

(8) The aliphatic ethers comprise in particular 4 to 24 carbon atoms. Mention may be made, as examples, of diethyl ether, ethyl propyl ether, hexyl ether, butyl ether and methyl t-butyl ether.

(9) (a) The alkylene glycol monoethers are in particular:

propylene glycol monoethers having 4 to 25 carbon atoms, such as propylene glycol monomethyl ether (PM), propylene glycol monoethyl ether (PE), propylene glycol mono-n-propyl ether (PNP), propylene glycol mono-tert-butyl ether (PTB), propylene glycol mono-n-butyl ether (PNB) and propylene glycol monohexyl ether;

ethylene glycol monoethers having 3 to 25 carbon atoms, such as ethylene glycol hexyl ether, ethylene glycol octyl ether and ethylene glycol phenyl ether.

(b) The dialkylene glycol monoethers are, for example:

dipropylene glycol monomethyl ether (DPM), dipropylene glycol mono-n-propyl ether (DPNP), dipropylene glycol mono-tert-butyl ether (DPTB), dipropylene glycol mono-n-butyl ether (DPNB) and dipropylene glycol monohexyl ether; and

diethylene glycol n-butyl ether (Butyl Diglycol Ether-BDG), diethylene glycol hexyl ether and diethylene glycol octyl ether.

(c) The trialkylene glycol monoethers are, for example:

tripropylene glycol monomethyl ether (TPM) and tripropylene glycol mono-n-butyl ether (TPNB).

(10) (a) The alkylene glycol diethers are in particular:

propylene glycol diethers having 5 to 25 carbon atoms, such as propylene glycol dimethyl ether; propylene glycol benzyl methyl ether; propylene glycol butyl methyl ether; and propylene glycol dibutyl ether;

ethylene glycol diethers having 4 to 25 carbon atoms, such as ethylene glycol diethyl ether and ethylene glycol dibutyl ether.

(b) The dialkylene glycol diethers are, for example, dipropylene glycol dimethyl ether, dipropylene glycol butyl methyl ether and dipropylene glycol dibutyl ether.

Mention may be made, as examples of solvents belonging to these families (9) and (10), of the “Arcosolv” solvents from the Company “Arco Chemical” and the “Dowanol” solvents from the Company “Dow Chemical Company”: PM, PE, PNP, PTB, PNB, DPNP, DPTB, DPNB, TPM and TPNB.

(11) (a) The alkylene glycol ether acetates are in particular:

propylene glycol ether acetates having 5 to 25 carbon atoms, such as propylene glycol methyl ether acetate (PM Acetate), propylene glycol ethyl ether acetate (PE Acetate) and propylene glycol butyl ether acetate; and

ethylene glycol ether acetates having 4 to 25 carbon atoms, such as ethylene glycol ethyl ether acetate and ethylene glycol butyl ether acetate.

(b) The dialkylene glycol ether acetates are, for example, dipropylene glycol methyl ether acetate (DPM Acetate) and diethylene glycol butyl ether acetate.

Mention may be made, as examples of solvents belonging to this family (11), of the “Arcosolv” and “Dowanol” solvents PM Acetate, PE Acetate and DPM Acetate.

Mention may be made, as preferred organic solvents, of aliphatic hydrocarbons, aromatic hydrocarbons, alkylene glycol monoethers, dialkylene glycol monoethers, trialkylene glycol monoethers, alkylene glycol diethers, dialkylene glycol diethers, alkylene glycol ether acetates and dialkylene glycol ether acetates.

Mention may also be made, as constituent (B), of a mixture of organic solvents, a portion of which is composed of at least one from the ethers of the abovementioned families (9), (10) and (11). These ethers can also act as cosurfactants. This is why it is advantageously possible to prepare a formulation which comprises them in a lower amount than the other solvent (B) or than the other solvents (B), it also being possible, but not essential, for this amount to be less than the amount of surface-active agent (A).

The composition according to the invention can additionally comprise:

at least one sequestering agent, such as ethylenediaminetetraacetic acid (EDTA) and its salts, in a proportion in particular of 0.01 to 0.1 part by weight per 100 parts by weight of (A)+(B)+(C); and/or

at least one chelating agent, chosen in particular from crown ethers, in a proportion in particular of 0.01 to 0.1 part by weight per 100 parts by weight of (A)+(B)+(C); and/or

at least one corrosion inhibitor, chosen in particular from organic acids of R^{o}—COOH type, R^{o} being a C₄-C₂₄ hydrocarbonaceous radical, and amines, in a proportion in particular of 0.01 to 0.5 part by weight per 100 parts by weight of (A)+(B)+(C); and/or

at least one additive, in the usual amounts, chosen from disinfectants, fungicides (quaternary ammonium salts) and biocides (organic peroxides, hydrogen peroxide, compounds comprising active halogen, inorganic phenol salts, quaternary ammonium salts, organometallic derivatives or organosulphur derivatives); and/or

at least one fragrance.

The microemulsions according to the invention are prepared by mixing the constituents in any order at room temperature. The essential point or factor is to be within the stability range of the microemulsion, this range being determined by a simple measurement of the temperature. From this fact, the addition of all the ingredients in one order or another will result in the rapid formation of the microemulsion.

When used, the microemulsions according to the invention are applied to the surfaces to be cleaned using a brush or rag. According to the nature of the application and the subsequent operations, rinsing with water may be necessary.

The following examples illustrate the present invention without, however, limiting the scope thereof. In these examples, the ingredients used were as follows:

Solvents

Solvent No. 1=Isoparaffin solvent sold by the Company “Exxon Corporation” under the name “Isopar™ H”

Solvent No. 2=Hydrocarbonaceous solvent sold by the Company “Exxon Corporation” under the name “Exxsol D 100S”

Solvent No. 3=Hydrocarbonaceous solvent sold by the Company “Cepsa” under the name “Petrosolv D 20/26”

Solvent No. 4=Hydrocarbonaceous solvent sold by the Company “Cepsa” under the name “Petrosolv D 24/27”

Solvent No 5=Hydrocarbonaceous solvent sold by the Company “Cepsa” under the name “Petrosolv D 28/31”

Cosolvents

BDG=Butyl diglycol ether or 2-(2-butoxy-ethoxy)ethanol, sold by the Company “B.P. Chimie”

PNB=propylene glycol n-butyl ether, sold under the name “Dowanol™ PNB” by the Company “The Dow Chemical Company”

DPNB=dipropylene glycol n-butyl ether, sold under the name “Dowanol™ DPNB” by the Company “The Dow Chemical Company”

PTB=propylene glycol mono-tert-butyl ether, sold under the name “Arcosolv PTB” by the Company “Arco”.

Surface-Active Agent

The surface-active agent used is the compound of formula:

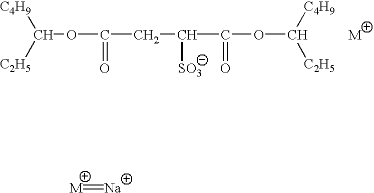

sold by the Company “Albright & Wilson Iberica” under the name “Empimin OP 070”.

In these examples, all the proportions mentioned are in parts by weight.

### PREPARATION EXAMPLES 1 to 10

General Procedure

400 g of a microemulsion are prepared with stirring in a 500 ml Erlenmeyer flask by mixing, at room temperature, the ingredients in the proportions indicated in Table 1 hereinbelow. Mixing is instantaneous and the formulation obtained is completely transparent.

TABLE 1

| | Example | | | | | | | | | |
|---|---|---|---|---|---|---|---|---|---|---|
| Composition | 1 | 2 | 3 | 4 | 5 | 6 | 7 | 8 | 9 | 10 |
| Water | 40 | 35 | 40 | 39 | 37 | 42 | 42 | 37 | 37 | 42 |
| Solvent No. 1 | 40 | — | 40 | 39 | | | | | | |
| Solvent No. 2 | — | 35 | — | — | 37 | | | | | |
| Solvent No. 3 | — | — | — | — | — | 30 | 33 | | | |
| Solvent No. 4 | — | — | — | — | — | — | — | 28 | | |
| Solvent No. 5 | — | — | — | — | — | — | — | — | 20 | 23 |
| BDG | — | — | 2 | | | | | | | |
| PNB | — | — | — | — | — | 13 | — | — | 8 | |
| DPNB | — | — | — | 8 | 8 | — | — | — | 10 | 20 |
| PTB | — | — | — | — | — | — | 10 | 10 | | |
| Surfactant | 20 | 25 | 18 | 14 | 18 | 15 | 15 | 25 | 25 | 15 |

### TEST EXAMPLE 11

Test Protocol

Approximately 2 g of a contaminant are painted with a brush on to a 5×5 cm stainless steel mesh in the form of a cylinder, this contaminant being composed of:

| | |
|---|---|
| Engine oil (Planetelf ACD 32) | 28.5 |
| Pump oil (Oleoflux CPO AC) | 28.5 |
| Grease (Equateur Rose) | 14.3 |
| Fontainebleau sand | 14.3 |
| Powdered charcoal | 14.4 |
| | 100 |

This combination is accurately weighed.

The mesh, thus prepared, is immersed in 100 ml of the microemulsion to be evaluated. The mesh is weighed after 1, 5, 10 and 15 minutes, which makes it possible to monitor the loss of contaminant (efficiency), expressed in % by weight, removed by the solvent.

Results

The efficiencies obtained with the compositions of Examples 3 and 6 and of two commercial comparative microemulsions ME1 and ME2 are presented in Table 2 hereinbelow.

TABLE 2

| Efficiency (%) | | | | |
|---|---|---|---|---|
| Composition of | Time (min.) | | | |
| Example | 1 | 5 | 10 | 15 |
| 3 | 7 | 51 | 89 | 97 |
| 6 | 2 | 34 | 70 | 93 |
| ME1* | 0 | 12 | 48 | 79 |
| ME2** | 0 | 2 | 36 | 61 |

*ME1: Microemulsion composed essentially, in % by weight, of:
- 15% of aliphatic hydrocarbons;
- 15% of propylene glycol mono-n-butyl ether;
- 15% of dipropylene glycol mono-n-propyl ether;
- 5% of a mixture of sodium dodecylbenzenesulphonate and of a mixture of sodium eicosanoylbenzenesulphonate and sodium tetracosanoylbenzenesulphonate; and
- 50% of water.
**ME2: Microemulsion composed essentially of:
- 10% of DL-limonene;
- 40% of glycol ether;
- 10% of sodium dodecylbenzenesulphonate; and
- 40% of water.

In all cases, final rinsing with water made it possible to obtain surfaces free from contaminants.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above and below, and of corresponding French application 99/07.848, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1. Cleaning composition which is provided in the form of a microemulsion which is stable at room temperature, the said composition comprising:
(A) water;
(B) at least one organic solvent which is liquid at room temperature; and
(C) at least one surface-active agent, characterized in that:
(A) represents from 30 to 70 parts by weight;
(B) represents from 20 to 60 parts by weight; and
(C) represents from 5 to 30 parts by weight,
(A)+(B)+(C) representing 100 parts by weight; and
the organic solvent or solvents (B) being chosen from:
(1) aliphatic alcohols;
(2) aliphatic esters;
(3) aliphatic diesters;
(4) aliphatic hydrocarbons;
(5) halogenated aliphatic hydrocarbons;
(6) aromatic hydrocarbons;
(7) aliphatic ketones;
(8) aliphatic ethers;
(9) alkylene glycol, dialkylene glycol and trialkylene glycol monoethers;
(10) (di)alkylene glycol diethers; and
(11) (di)alkylene glycol ether acetates; and
the surface-active agent or agents (C) being chosen from those of the formula (I): 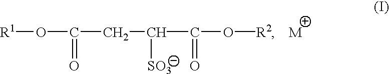
in which:
R¹ and R² each independently represent a linear or branched C₅-C₂₀ alkyl radical;
M is a cation chosen from Na⁺, K⁺ and NR₄⁺, the R groups each independently representing hydrogen or a C₁-C₄ alkyl radical.

2. Composition according to claim 1, characterized in that:
(A) represents 35 to 60 parts by weight;
(B) represents 25 to 55 parts by weight; and
(C) represents 10 to 25 parts by weight.

3. Composition according to either of claims 1 and 2, characterized in that the organic solvent or solvents (B) are chosen from aliphatic hydrocarbons, aromatic hydrocarbons, alkylene glycol monoethers, dialkylene glycol monoethers, trialkylene glycol monoethers, alkylene glycol diethers, dialkylene glycol diethers, alkylene glycol ether acetates and dialkylene glycol ether acetates.

4. Composition according to either of claims 1 and 2, characterized in that the constituent (B) is a mixture of organic solvents, a portion of which is composed of at least one from the ethers of the families (9), (10) and (11).

5. Composition according to one of claims 1 to 4, characterized in that it additionally comprises at least one sequestering agent, chosen in particular from ethylenediaminetetraacetic acid and its salts, in a proportion in particular of 0.01 to 0.1 part by weight per 100 parts by weight of (A)+(B)+(C).

6. Composition according to one of claims 1 to 5, characterized in that it additionally comprises at least one chelating agent, chosen in particular from crown ethers, in a proportion in particular of 0.01 to 0.1 part by weight per 100 parts by weight of (A)+(B)+(C).

7. Composition according to one of claims 1 to 6, characterized in that it additionally comprises at least one corrosion inhibitor, chosen in particular from acids of R^{o}—COOH type, R^{o} being a C₄-C₂₄ hydrocarbonaceous radical, and amines, in a proportion in particular of 0.01 to 0.5 part by weight per 100 parts by weight of (A)+(B)+(C).

8. Composition according to one of claims 1 to 7, characterized in that it additionally comprises at least one additive chosen from disinfectants, fungicides and biocides.

9. Composition according to one of claims 1 to 8, characterized in that it additionally comprises at least one fragrance.
